(19) United States
(12) Patent Application Publication
(10) Pub. No.: US 2001/0047659 A1
(43) Pub. Date: Dec. 6, 2001

(54) Air-conditioning system for vehicles

(76) Inventors: Hiroki Nakamura, Chiryu-city (JP); Hiroshi Nonoyama, Toyota-city (JP); Yoshimitsu Inoue, Chiryu-city (JP); Yuji Takeo, Toyoake-city (JP); Mitsuyo Oomura, Hekinan-city (JP); Eiji Takahashi, Toyohashi-city (JP); Toshinobu Homan, Obu-city (JP); Osamu Kasebe, Kariya-city (JP)

Correspondence Address: HARNESS, DICKEY & PIERCE, PLC, P.O. BOX 828, BLOOMFIELD HILLS, MI, 48303, US

(21) Appl. No.: 09/843,969

(22) Filed: Apr. 27, 2001

(30) Foreign Application Priority Data
Apr. 27, 2000 (JP) 2000-128252
Dec. 22, 2000 (JP) 2000-391122
Apr. 11, 2001 (JP) 2001-113075

(51) Int. Cl. F25B 1/00; B60H 1/32

(52) U.S. Cl. 62/190; 62/239

(57) ABSTRACT

When an after-evaporation temperature TE remains below the wet-bulb temperature Twet, the compressor 231 is intermittently operated for a predetermined time after the elapse of a first time To from compressor 231 stopping. On the other hand, when the after-evaporation temperature TE is higher than the wet-bulb temperature Twet, the intermittent operation mode stops. This reduces dispersion of offensive smells from the evaporator.

### CROSS-REFERENCE TO RELATED APPLICATION

The present invention is related to Japanese patent application No. 2000-128252, filed Apr. 27, 2000; 2000-391122, filed Dec. 22, 2000; 2001-113075, filed Apr. 11, 2001, the contents of which are incorporated herein by reference.

### FIELD

This invention relates to a vehicle air-conditioning system, and more particularly, to an vehicle air-conditioning system useable in a hybrid vehicle and a economy-run vehicle.

### BACKGROUND

A vehicle air-conditioning compressor is generally driven by an engine, and in the case of a hybrid vehicle and an economy-run vehicle, the compressor will stop if the engine stops even when the air conditioning system is ON. The surface of the evaporator commonly has debris that emits offensive smells (perfume, new vehicle trim, cigarettes). Usually, these offensive smells are covered with condensate that holds them to the surface of the evaporator. As such, they do not scatter into the vehicle interior.

However, if the compressor stops operating, the condensate holding the particles to the evaporator evaporates, and therefore offensive smells leave the evaporator with the air-conditioned fresh air into the vehicle interior. According to JP-A No. Hei 11-198644, the compressor stops until offensive smells are detected, thereafter being restarted to thereby prevent offensive smells from entering the vehicle interior. Furthermore, the compressor operates until the air temperature passing the evaporator lowers to a predetermined value, and then is stopped again. However, the compressor should operate until immediately before the occurrence of an offensive smell, and also until the temperature of the air after passing through the evaporator lowers to the predetermined value. Because of this, it is difficult to decrease compressor speed.

### SUMMARY

In view of the above-described disadvantages, the present invention provides an air-conditioning system having a compressor which compresses refrigerant, and an evaporator mounted inside of an air-conditioner casing forming an air passage through which the fresh air is blown into the vehicle interior, to thereby cool the air by evaporating the refrigerant. According to this invention, the air-conditioning system has a first clock means which measures time from compressor stop, and a second clock means which measures time after compressor start, so that the compressor will start when the time measured by the first clock means after compressor stop has reached a first predetermined time. The compressor operates until the time measured by the second clock means reaches a second predetermined time which is shorter than the first predetermined time.

The flow velocity of the refrigerant at which the ratio of surface sweating (the velocity at which the surface of the evaporator dries) can be decreased by the short-time flow of the refrigerant in the evaporator, thereby keeping offensive smells covered with condensate. Furthermore, since the compressor is operated after the lapse of the first predetermined time To after the compressor has been stopped, the rate of operation of the compressor can be lowered.

In another aspect of the invention, the compressor and the evaporator are mounted inside of the air-conditioner casing forming an air passage through which the fresh air is blown into the vehicle interior, thereby cooling the air by evaporating the refrigerant. According to this invention, the air-conditioning system has a first clock means which measures time from compressor stop, and a second clock means which measures time after the start of the compressor. An intermittent operation mode is executed to perform the compressor on-off operation to stop the compressor until the compressor after stopping, will be kept stopped until a time measured by the first clock means reaches a first predetermined time, and thereafter to operate the compressor until the time measured by the second clock means reaches a second predetermined time that is shorter than the first predetermined time.

Thus, the rate of evaporation (the rate at which the surface of the evaporator dries) is reduced by the short-time flow of the refrigerant to the evaporator. Therefore, offensive smells are covered with condensate for a long time.

In another aspect, the intermittent operation mode stops when the air passing the evaporator exceeds the wet-bulb temperature of the evaporator. When the temperature of the air flowing through the evaporator has exceeded the wet-bulb temperature of the evaporator, the offensive smells usually have scattered. Therefore, the rate of operation of the compressor is reduced to reduce fuel consumption by stopping the intermittent operation mode when the temperature of the air after passing the evaporator exceeds the wet-bulb temperature.

The temperature of the air passing the evaporator sometimes remains below the wet-bulb temperature depending on the operating condition of the air-conditioning system. As such, in another aspect, when the operation frequency of the compressor has reached a specific frequency after starting the intermittent operation mode, the intermittent operation mode will stop. Prolonged continuous execution of the intermittent operation mode, therefore, can be prevented.

Next, In another aspect, the first predetermined time may be increased according to an increase in the humidity of air introduced into the air-conditioner casing.

In another aspect, the first predetermined time To may be increased according to an increase in air humidity introduced into the air-conditioner casing.

In another aspect, the first predetermined time To may be increased according to a decrease in the volume of air flowing in the air-conditioner casing.

In another aspect, the first predetermined time To in the inside air circulation mode in which the inside air of the vehicle is introduced into the air-conditioner casing may be increased as compared with that in the outside air introduction mode in which the outside air is introduced into the air-conditioner casing.

Furthermore, in another aspect, the first predetermined time To may be decreased according to an increase in vehicle speed, in the outside air introduction mode in which the outside air is introduced into the air-conditioner casing.

In another aspect, the first predetermined time To may be increased according to an increase in the amount of solar radiation entering the vehicle interior in the inside air circulation mode in which the inside air of the vehicle interior is introduced into the air-conditioner casing.

When the compressor is driven by the driving source, it is desirable to stop the intermittent operation mode when stopping the driving source as stated in claim 11 of this invention.

Further areas of applicability of the present invention will become apparent from the detailed description provided hereinafter. It should be understood that the detailed description and specific examples, while indicating preferred embodiments of the invention, are intended for purposes of illustration only, since various changes and modifications within the spirit and scope of the invention will become apparent to those skilled in the art from this detailed description. In the drawings:

### BRIEF DESCRIPTION OF THE DRAWINGS

The present invention will become more fully understood from the detailed description and the accompanying drawings, wherein:

FIG. 1 is a schematic view of a hybrid vehicle to which an air-conditioning system according to a first embodiment of this invention is applied;

FIG. 2 is a schematic view of the air-conditioning system according to the first embodiment of this invention;

FIG. 3 is a schematic view of a control system of the air-conditioning system according to the first embodiment of this invention;

FIG. 4 is a flowchart describing the air-conditioning system according to the first embodiment of this invention;

FIG. 5 is a wet air diagram according to the present invention;

FIG. 6A is a graph showing a relation between the after-evaporation wet-bulb temperature TE and time;

FIG. 6B is a graph showing a relation between the rate of wetting of the evaporator surface and time;

FIG. 6C is a graph showing a relationship between the intensity of offensive smell and time;

FIG. 6D is a graph showing four kinds of intensities of offensive smell shown in FIG. 6C;

FIG. 6E is a schematic view of an evaporator showing places of measurements shown in FIGS. 6A-6C for the present invention; and

FIG. 7 is a flow chart of another embodiment of the present invention.

### DETAILED DESCRIPTION

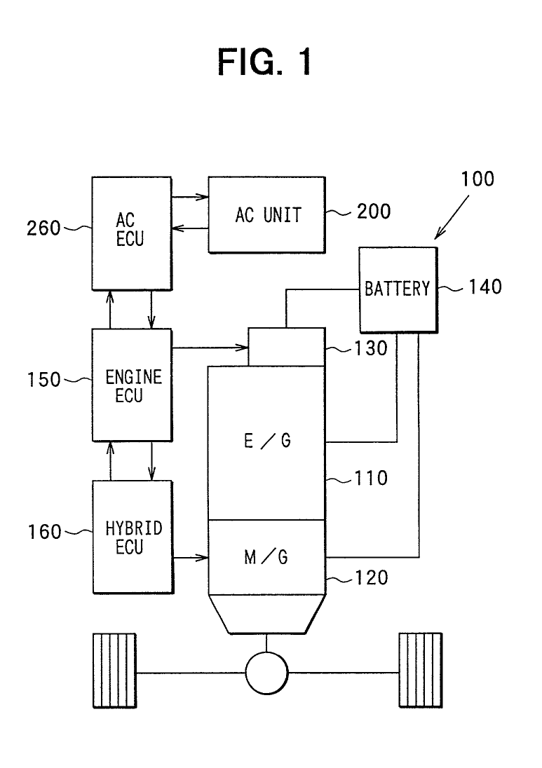

In a first embodiment, as shown in FIG. 1, the invention is used with a hybrid vehicle 100. Vehicle 100 is comprised of an engine (internal combustion engine) 110 for driving the vehicle; a motor (motor generator) 120 having both a motor function as a source of driving force and a generating function; an engine control 130 comprising a starting motor for starting the engine 110, an ignition system, and a fuel injection system; a battery (secondary battery) 140 for supplying the electric power to the motor 120 and the engine control 130; an electronic control unit (EECU) 150 for controlling the engine control unit 130; and an electronic control unit (MECU) 160 for controlling the motor 120 through EECU 150.

In this embodiment, the engine 110 and the motor 120 are controlled based on various vehicle information such as the driving state of the vehicle and the charged condition of the battery 140. Concretely speaking, the vehicle is operated by power from engine 110, or by power of both engine 110 and motor 120, or by power generated (regenerative braking) by the motor 120.

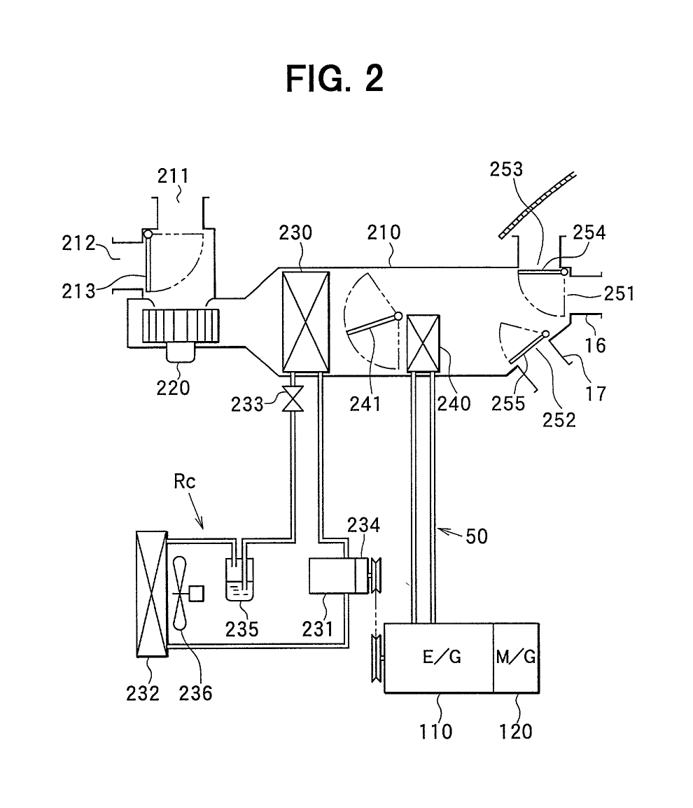

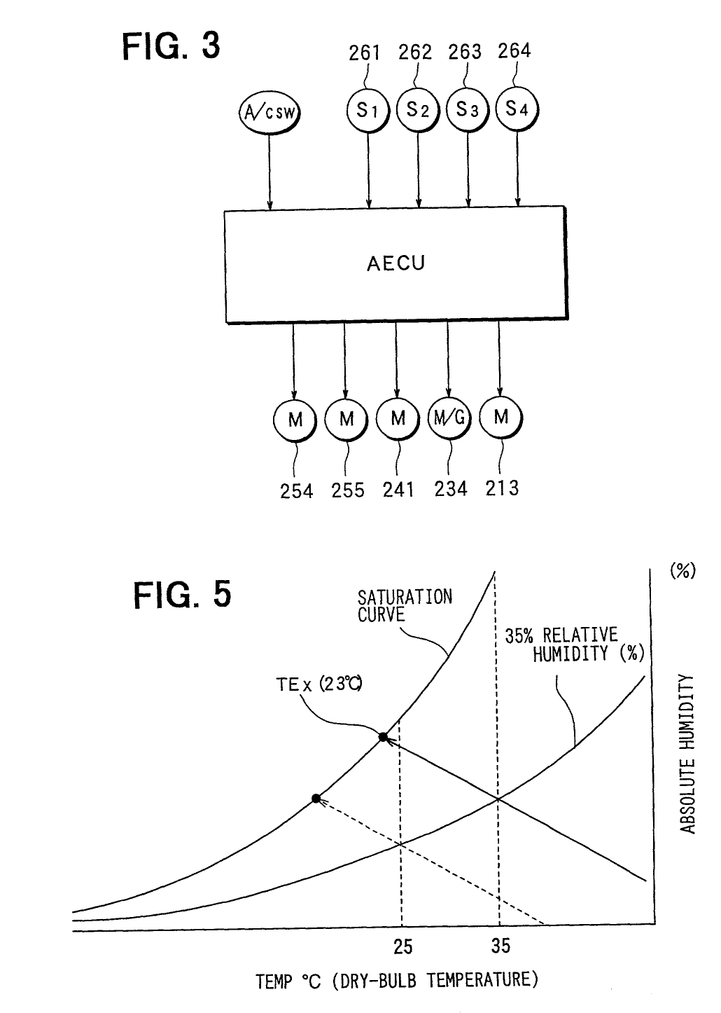

FIG. 2 is a schematic view of an air-conditioning system 200, in which 210 denotes an air-conditioner a resin casing (polypropylene in this embodiment) which forms an air passage blowing air into the vehicle interior. At the maximum upstream location of the air-conditioned air flow of the air-conditioner casing 210 is an outside air inlet port 211 at which the outside air is drawn into the air-conditioner casing 210, and an inside air inlet port 212 at which the inside air is drawn into the air-conditioner casing 210. Both the inlet ports 211 and 212 are controlled to open and close with an inside-outside air changeover door 213.

Numeral 220 refers to a centrifugal fan for supplying air, and numeral 230 is an evaporator for cooling the air-conditioned air. Downstream of the air-conditioned air flow of the evaporator 230, a heater core 240 is located to heat the air-conditioned air by using cooling water from the engine 110 as a heat source. Then, numeral 241 denotes an air mixing door for adjusting the temperature of air blown into the vehicle interior by adjusting the air-conditioned air (cold air) passing through the evaporator 230, the volume of air passing through the heater core 240 and the volume of air flowing around the heater core 240.

Numeral 251 denotes a face air outlet where the air-conditioned air (the temperature of which has been controlled by the air mixing door 241) is blown out to the head area of the vehicle's occupants. Numeral 252 denotes a foot air outlet at which the temperature-controlled air-conditioned air is blown out to the foot area of the vehicle's occupants. And, numeral 253 denotes a defroster air outlet at which the temperature-controlled air-conditioned air is blown out to the windshield glass.

Numeral 254 is a first blow-out mode door which opens and closes to switch between the face air outlet 251 and the defroster air outlet 252. Numeral 255 is a second blow-out mode door which opens and closes the foot air outlet 252. By controlling these air blow-out mode doors 254 and 255, the face mode for supplying the air-conditioned air to the head area of the vehicle's occupants, the foot mode for supplying the air-conditioned air to the foot area of the vehicle's occupants, and the defroster mode for supplying the air-conditioned air to the windshield glass are performed.

The evaporator 230 is a heat exchanger on the low-pressure side of a steam compression type refrigeration cycle (hereinafter referred to as the refrigeration cycle) Rc in which the refrigerating capacity can be fully performed through the evaporation of refrigerant. The refrigeration cycle, as is well known, includes the compressor 231 for compressing the refrigerant, a condenser 232 for cooling (condensing) the refrigerant by heat exchange between the air and the refrigerant compressed by the compressor 231, a pressure reducer 233 for the pressure of the refrigerant cooled by the condenser 232, and the evaporator 230.

In this embodiment, the compressor 231 is operated by engine 110 through an electromagnetic clutch (clutch means) 234 which intermittently transmits the driving force, and a V belt (not shown). When engine 110 is stopped by a demand on the vehicle side (EECU 150 and MECU 160 side), the electromagnetic clutch 234 stops the compressor 231 even when the electromagnetic clutch 234 is enabling transmission of driving force.

Numeral 235 represents a receiver which separates the refrigerant flowing out from condenser 232, to an air-phase refrigerant and a liquid-phase refrigerant, storing excess refrigerant. Numeral 236 denotes a condenser fan which supplies cool air to the condenser 232.

The air-conditioning system, including the inside-outside air changeover door 213, the fan 220, the electromagnetic clutch 234, the condenser fan 236, the air mixing door 241, and the blow-out mode doors 254 and 255, is controlled by an electronic control unit (AECU) for the air-conditioning system 260 (see FIG. 1).

The AECU 260 is supplied with signals from such air-conditioning sensors as an inside temperature sensor (inside temperature detecting means) 261 which detects the temperature of inside air, an outside temperature sensor (outside temperature detecting means) 262 which detects the temperature of outside air, an after-evaporation sensor (temperature detecting means) 263 which detects the air-conditioned air temperature immediately after passing through the evaporator 230, and a humidity sensor (humidity detecting means) 264 which detects the relative humidity of inside air.

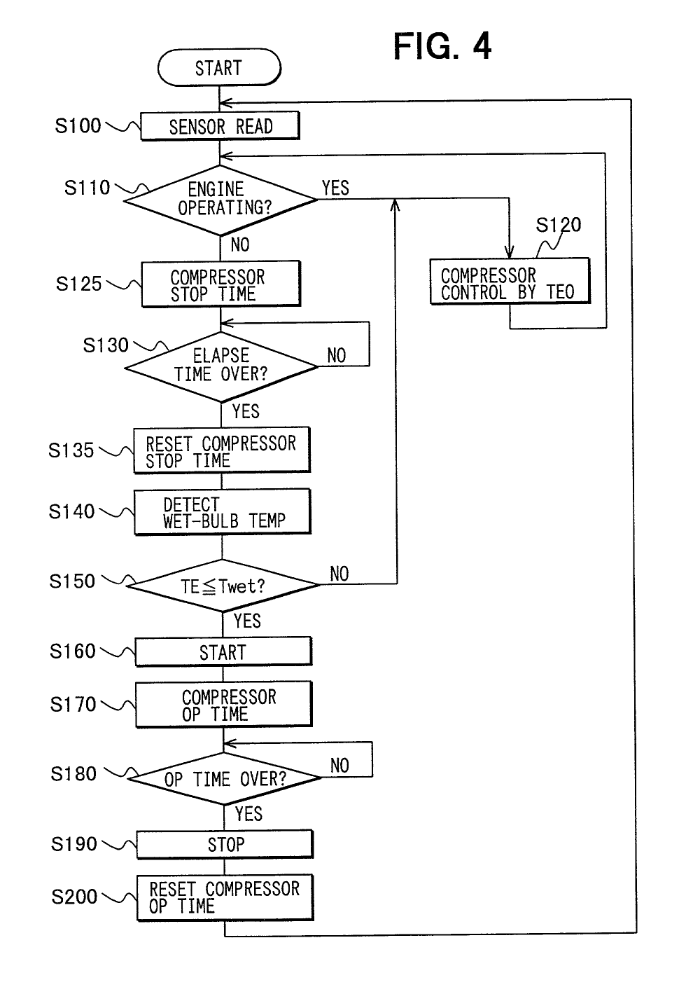

Next, the characteristic operation of this embodiment (AECU 260) will be described with reference to the flowchart shown in FIG. 4.

When the starting switch (A/C switch) of the air-conditioning system is turned on, the fan 220 is operated, also turning on the electromagnetic clutch 234. At this time, almost simultaneously, detected values of the air-conditioning sensors 261 to 264 are read in (S100). Then, whether or not the engine 110 is operating is determined according to a signal from the EEC 150. When the engine 110 is operating, the electromagnetic clutch 234 is on-off controlled (S120) so that the detected temperature of the after-evaporation sensor 263 (hereinafter referred to as the after-evaporation temperature TE) is a target after-evaporation temperature TEO. In this embodiment, a 1° C. hysteresis has been set for the target after-evaporation temperature TEO. Concretely, the hysteresis has been set at 3° C.-4° C. when the determination is YES at S110, and at 25° C.-26° C. when the determination is NO at S150.

On the other hand, when the engine is stopped, an elapsed time is measured with reference to the time the engine 110 stopped. That is, from the time the compressor 231 stopped, according to a signal from the EECU 150, it is determined whether or not the elapsed time exceeds a first predetermined time (hereinafter referred to the predetermined elapsed time To). When the elapsed time exceeds the predetermined elapsed time, the measured compressor stop time is reset at S135, and thereafter the wet-bulb temperature Twet of the evaporator 230 is detected at S140.

In this embodiment, the elapsed time To is about 30 seconds, and the later-described required operation time Ts is about 1 second. The elapsed time To and the time required for operation Ts vary with the size (surface area) of the evaporator 230 and the air temperature flowing into the evaporator 230.

The wet-bulb temperature Twet is the surface temperature of the evaporator 230 with the surface of the evaporator 230 wet with condensate. While the surface of the evaporator 230 is wet with condensate, the after-evaporation temperature TE is below the wet-bulb temperature Twet. The wet-bulb temperature Twet is determined by the temperature (dry-bulb temperature) and humidity (relative humidity) of the air (suction air) flowing into the evaporator 230. And, in this embodiment, in the inside air circulation mode in which the inside air is introduced, the wet-bulb temperature Twet is computed based on detected values from the inside temperature sensor 261 and the humidity sensor 264 and the wet air diagram shown in FIG. 5 pre-stored in the ROM. Also, in the outside air introduction mode in which the outside air is introduced, the wet-bulb temperature Twet is the after-evaporation temperature TE after the lapse of a specific time (30 seconds in this embodiment) after the compressor 231 (engine 110) is stopped.

When the temperature (dry-bulb temperature) of the air (suction air) flowing into the evaporator 230 is 35° C. and the relative humidity is 35%, the wet-bulb temperature Twet using FIG. 5 is the temperature TEx of 23° C. corresponding to a point of intersection TEx of the isenthalpic curve and the saturation curve passing through the intersection P of the dry-bulb temperature and the relative humidity.

Then, when the after-evaporation temperature TE is lower than the wet-bulb temperature Twet as a result of comparison between these temperatures, a request (hereinafter referred to the requirement for starting) is made to the EECU 150 at S160 to start engine 110.

Next, at S170, the compressor operation time is measured. Then, at S180, whether the operation time has exceeded a second predetermined time (hereinafter the required operation time Ts) is determined. When the required operation time is exceeded, a request is made to the EECU 150 at S190 to stop the engine 110, subsequently resetting the compressor operation time at S200, and returning to S100. On the other hand, when the after-evaporation temperature TE is higher than the wet-bulb temperature Twet, the process proceeds to S120.

Next, advantages (operation effect) of this embodiment will be described.

While the after-evaporation temperature TE is below the wet-bulb temperature Twet, the engine 110 stops to stop the compressor 231. The compressor 231 remains at a stop until the compressor stop time reaches the elapsed time To. Thereafter, the on-off operation is intermittently carried out to operate the compressor 231 for the required operation time Ts (hereinafter the intermittent operation mode). On the other hand, when the after-evaporation temperature TE is higher than the wet-bulb temperature Twet, the intermittent operation mode is stopped. Therefore, the rate of evaporation is reduced by the short-time flow of the refrigerant through the evaporator 230 (the rate at which the surface of the evaporator 230 dries).

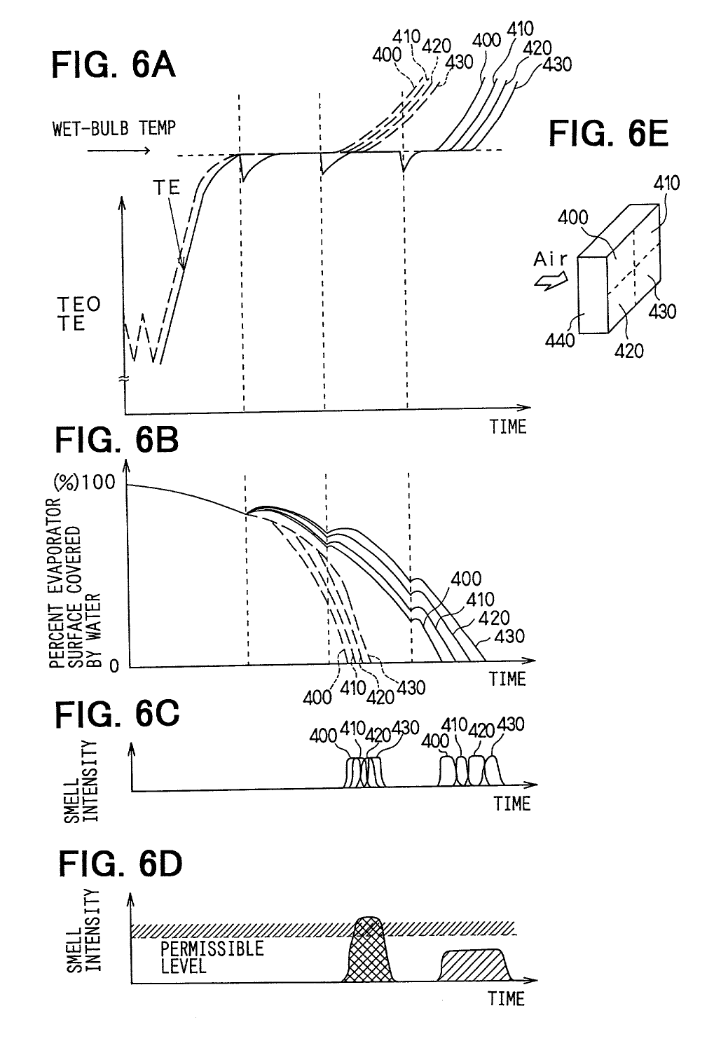

The thick solid line in FIG. 6A indicates the behavior of the after-evaporation temperature TE in the air-conditioning system according to this embodiment. The thick broken line in FIG. 6A indicates the behavior of the after-evaporation temperature TE in other than the intermittent operation mode. Numerals 400, 410, 420 and 430 indicate measuring points of the after-evaporation temperature TE (refer to evaporator 440 in FIG. 6E). A thick solid line in FIG. 6B indicates the behavior of evaporation from the surface of evaporator 230 in the air-conditioning system according to this embodiment, while a thick broken line in FIG. 6B indicates the behavior of the evaporation rate from the evaporator 230 in other than the intermittent operation mode.

As is clear from the graphs of FIGS. 6A and 6B, since the rate of evaporation from the evaporator 230 is lowered, much of offensive smells from the surface of the evaporator 230 can be restrained from entering the vehicle interior. Also, as shown in FIG. 6C, the intensity of offensive smell can be restrained to lower than the permissible level. FIG. 6D gives a combination of graphs of 400, 410, 420 and 430 in FIG. 6C.

When the after-evaporation temperature TE is higher than the wet-bulb temperature Twet, all the offensive smells are gone as shown in FIG. 6C. Therefore, if the intermittent operation mode is stopped when the after-evaporation temperature TE is higher than the wet-bulb temperature Twet like in this embodiment, the fuel consumption can be further reduced by decreasing the rate of operation of the compressor 231.

In addition, at step s110 in FIG. 4, whether the defogging mode is necessary can be determined. In this case, when the defogging mode is necessary, temperature of the evaporator is forced lower to a predetermined low temperature (ex. 3-4 degrees C.) at step s120. When the defogging mode is determined unnecessary, after TEO is set higher than the wet bulb temperature, the process moves to s125

As such, whether defogging is necessary, for example, may be determined by whether the DEF mode switch is turned on or the detected humidity is more than a predetermined value.

(Second Embodiment)

In the above-described embodiment, the predetermined elapsed time To was fixed. In this embodiment, however, the predetermined elapsed time To is changed according to the introduced air temperature to prolong the predetermined elapsed time To according to the temperature rise of the air introduced into the air-conditioner casing 210. When the air temperature rises while the relative humidity of the introduced air remains nearly constant, regardless of the air temperature, the absolute humidity of the introduced air rises because of the nearly constant relative humidity.

The higher the introduced air temperature, the lower the rate of evaporation from the evaporator 230. Therefore, increasing the predetermined elapsed time To according to the temperature rise of the introduced air can lower the rate of operation of the compressor 231, thereby further decreasing the fuel consumption.

(Third Embodiment)

In the first embodiment, the predetermined elapsed time To was constant. In this embodiment, however, the predetermined elapsed time To increases according to an increase in the humidity of the introduced air.

(Fourth Embodiment)

In the first embodiment, the predetermined elapsed time To was constant. In this embodiment, however, the predetermined elapsed time To increases with a decrease in the volume flow of air (electric voltage applied to the fan 220) flowing through in the air-conditioner casing 210.

(Fifth Embodiment)

In the first embodiment, the predetermined elapsed time To was constant. In this embodiment, however, the predetermined elapsed time To is set longer in the inside air circulation mode in which the inside air is drawn into the air-conditioner casing 210 than in the outside air introduction mode in which the outside air is drawn into the air-conditioner casing 220.

This is because that generally the relative humidity and absolute humidity of the introduced air become higher in the inside-air circulation mode than in the outside-air introduction mode, and therefore the rate of lowering of the evaporation rate from the evaporator 230 decreases more in the inside-air circulation mode than in the outside-air introduction mode.

(Sixth Embodiment)

In the first embodiment, the predetermined elapsed time To was constant. In this embodiment, however, the predetermined elapsed time To, in the outside-air introduction mode, is decreased with an increase in the vehicle speed. This is because that, in the outside-air introduction mode, the ram pressure increases with an increase in the vehicle speed and also the substantial volume of air flowing into the air-conditioner casing 210, thereby decreasing the predetermined elapsed time To according to an increase in the vehicle speed to restrain an increase in the rate of lowering of the surface wetting ratio of the evaporator 230.

(Seventh Embodiment)

In the first embodiment, the predetermined elapsed time To was constant. In this embodiment, however, there is provided a solar radiation quantity sensor (solar radiation detecting means) which detects the quantity of solar radiation entering the vehicle interior in the inside air circulation mode, to thereby prolong the predetermined elapsed time To with a decrease in the quantity of solar radiation. This is because the inside temperature lowers and the relative humidity in the vehicle interior increases with decreasing solar radiation, resulting in decreased evaporation from evaporator 230.

(Eighth Embodiment)

In the first embodiment, the intermittent operation mode is stopped when the after-evaporation temperature TE is higher than the wet-bulb temperature Twet. However, the after-evaporation temperature TE sometimes will not rise above the wet-bulb temperature Twet depending on the operating condition of the air-conditioning system. In this embodiment, therefore, if the after-evaporation temperature is under the wet-bulb temperature Twet, the intermittent operation mode will stop when the specific number of times the compressor 231 operates is reached (preferably 10 times in this embodiment) after the start of the intermittent operation mode. Here, one continuous period of operation (the required operation time Ts in this example) is counted as one time of operation of the compressor 231.

(Ninth Embodiment)

In the above-described embodiment, the intermittent mode is carried out, without depending on the operating condition of the engine (driving source) 110. In the hybrid vehicle, however, if the vehicle is running (during operation of the air-conditioning system), it is possible that the engine 110 will stop. In this embodiment, therefore, when the engine stops, the intermittent operation mode is stopped.

(Tenth Embodiment)

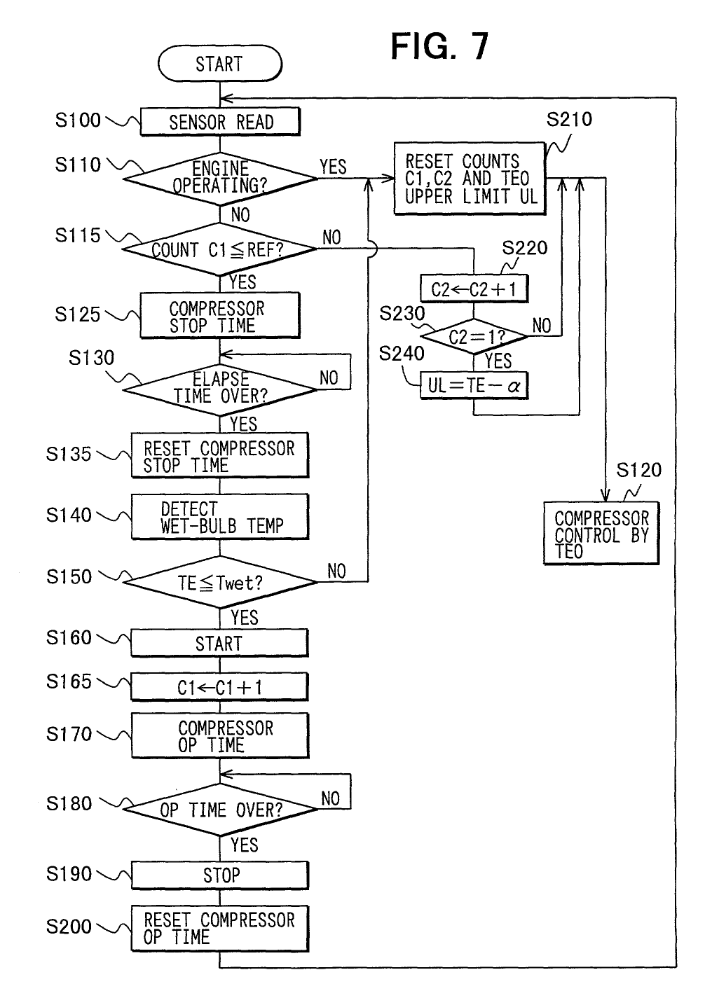

If the state where the after-evaporation temperature stays below the wet bulb temperature, the present invention may cycle indefinitely, thereby creating noise and causing discomfort to the driver. Therefore, in the tenth embodiment, as shown referring to FIG. 7, the process counts the specific number of times the compressor cycles as shown in s165. In step s115, the process compares the count cl with a reference. If the count exceeds the reference, the process moves to s220 where c2=c2 and 1. At s230, the process determines if c2=1. If so, s240 sets the current temperature as the target temperature. Thereafter, the compressor is controlled to achieve this target temp.

(Other Embodiments)

It should be noted that this invention is not limited to the embodiments explained above and may be a combination of the second to seventh embodiments.

In the first embodiment, the intermittent operation mode is stopped when the after-evaporation temperature TE is higher than the wet-bulb temperature Twet. With a comparison between the after-evaporation temperature TE and the wet-bulb temperature Twet abolished, the intermittent operation mode may be constantly performed while the A/C switch is in on position and the engine 110 stops.

In the embodiment stated above, during the inside-air circulation mode, the wet-bulb temperature Twet is operated (computed) based on the detected values of the inside temperature sensor 261 and the humidity sensor and the wet air diagram. During the outside-air introduction mode, the wet-bulb temperature Twet was the after-evaporation temperature TE after the lapse of the predetermined time (30 seconds in this embodiment) after the compressor 231 (engine 110) stops. It is understood, however, that this invention is not limited thereto and the wet-bulb temperature Twet may be determined by other means, for example based on the introduced air temperature, not in the outside-air introduction mode and the inside-air circulation mode, or may be either lower temperature of the after-evaporation temperature TE immediately after the stop of the compressor 231 (engine 110)and the detected temperature of the outside-air temperature sensor 262.

Furthermore, the application of this invention is not limited to hybrid vehicles and economy-run vehicles and may be applied to other general vehicles.

Furthermore, in the above-described embodiment the elapsed time To was about 30 seconds. It should be noted, however, that this invention is not limited thereto and may be 20 seconds or more and 90 seconds or less, and preferably 20 seconds or more and 60 seconds or less.

Furthermore, in the above-described embodiment the required operation time Ts was about 1 second; this invention, however, is not limited thereto and may be 0.5 second or more and 5 seconds or less, and preferably 0.5 seconds or more and 2 seconds or less.

While the above-described embodiments refer to examples of usage of the present invention, it is understood that the present invention may be applied to other usage, modifications and variations of the same, and is not limited to the disclosure provided herein.

What is claimed is:

1. A vehicle air-conditioning system which has a compressor for compressing refrigerant and an evaporator mounted inside an air-conditioner casing, said air-conditioner case forming an air passage to channel air into a vehicle interior, the air being cooled by evaporation of refrigerant in the evaporator, the vehicle air-conditioning system comprising:
a first clock means for measuring a first predetermined time after compressor stops operation; and
a second clock means for measuring a time after compressor stops operation;
wherein the compressor is operated until the time measured by the second clock means reaches a second predetermined time that is shorter than the first predetermined time.

2. A vehicle air-conditioning system which has a compressor for compressing refrigerant and an evaporator mounted inside an air-conditioner casing, said casing forming a passage to channel air into a vehicle interior, the air being cooled by evaporation of refrigerant in the evaporator, the vehicle air-conditioning system comprising:
a first clock means for measuring a time after compressor stops; and
a second clock means for measuring a time after the compressor stops;
wherein an intermittent operation mode is performed after the compressor stops to intermittently operate the compressor by stopping the compressor until the time measured by the first clock means reaches a first predetermined time, and thereafter operating the compressor until the time measured by the second clock means reaches a second predetermined time which is shorter than the first predetermined time.

3. A vehicle air-conditioning system according to claim 2, wherein the intermittent operation mode is stopped when a temperature of air passing through the evaporator has exceeded a wet-bulb temperature of the evaporator.

4. A vehicle air-conditioning system according to claim 2, wherein the intermittent operation mode is stopped when the compressor operates a predetermined number of times after the start of the intermittent operation mode.

5. A vehicle air-conditioning system according to claim 1, wherein the first predetermined time is increased according to the temperature rise of air introduced into the air-conditioner casing.

6. A vehicle air-conditioning system according to claim 1, wherein the first predetermined time is increased according to an increase in a humidity of air introduced into the air-conditioner casing.

7. A vehicle air-conditioning system according to claim 1, wherein the first predetermined time is increased with a decrease in a volume of air flowing in the air-conditioner casing.

8. A vehicle air-conditioning system according to claim 1, wherein the first predetermined time is increased longer during an inside-air circulation mode in which inside air is introduced into the air-conditioner casing than in an outside-air introduction mode in which outside air is introduced into the air-conditioner casing.

9. A vehicle air-conditioning system according to claim 8, wherein the first predetermined time is decreased with an increase in the vehicle speed during the outside air introduction mode.

10. A vehicle air-conditioning system according to claim 8, wherein the first predetermined time is increased with a decrease in solar radiation entering the vehicle interior during the inside-air circulation mode.

11. A vehicle air-conditioning system according to claim 1, wherein the compressor is driven by a driving source, the intermittent operation mode being stopped when the driving source stops.

12. An air conditioning system according to claim 1, further comprising:
a evaporator detecting means for detecting the evaporator temperature;
a wet bulb temperature detecting means for detecting wet-bulb temperature inside a vehicle compartment;
wherein the compressor is operated so that an evaporator temperature detected by the evaporator temperature detecting means becomes below a wet-bulb temperature detected by the wet-bulb temperature detecting means, after on/off operation mode starts, as well as when the compressor reaches a predetermined number of operation times.

13. An air conditioning system according to claim 1, wherein the second predetermined time period is a duration of time when the refrigerant reaches only a part of the evaporator while the compressor is being turned ON for a same duration of time.

14. A vehicle air-conditioning system for cooling a vehicle interior, comprising:
an evaporator;
a compressor fluidly communicating with said evaporator through a cooling circuit;
a processor having a first clock operation and a second clock operation, said compressor operating or stopping in response to said processor;
an evaporator air outlet temperature sensor providing an evaporator outlet temperature signal to said processor;
a wet bulb temperature sensor that detects a wet bulb temperature inside said vehicle interior, said wet bulb temperature sensor providing a wet bulb temperature signal to said processor;
wherein said processor obtains a wet bulb temperature from said wet bulb temperature sensor at a predetermined time after said compressor stops operating, said processor instructing said compressor to operate for a predetermined time when said wet bulb temperature is lower than a temperature detected by said evaporator air outlet temperature sensor.

15. A method for controlling a compressor of a cooling system, said cooling system having an evaporator and a compressor, said cooling system cooling an interior of a vehicle by blowing cooling air across the evaporator and into said interior, said method comprising:
stopping operation of the compressor;
comparing a wet bulb temperature inside the interior of the vehicle with a dry bulb temperature of air entering the evaporator after a first predetermined time passes from when said compressor is stopped;
operating said compressor for a second predetermined time if said wet bulb temperature is above a temperature of air exiting said evaporator; and
controlling said compressor so that said evaporator provides a target outlet temperature if said wet bulb temperature is below said temperature of air exiting said evaporator.

16. The method as claimed in claim 15, further comprising:
counting a number of times said compressor is operated for said first predetermined time when said wet bulb temperature is above said temperature of air exiting said evaporator; and
controlling said compressor to a target outlet temperature when said number of times reaches a predetermined number.

17. The method as claimed in claim 15, wherein the first predetermined time is increased with an increase in temperature of air entering the evaporator.

18. The method as claimed in claim 15, wherein the first predetermined time is increased with a humidity increase in air entering the evaporator.

19. The method as claimed in claim 15, wherein the first predetermined time is longer during an inside air circulation mode than during an outside air introduction mode.

20. The method as claimed in claim 15, wherein the first predetermined time is decreased with an increase in vehicle speed during the outside air introduction mode.
